(19) United States
(12) Patent Application Publication
(10) Pub. No.: US 2008/0100473 A1
(43) Pub. Date: May 1, 2008

(54) Spatial-temporal Image Analysis in Vehicle Detection Systems

(75) Inventors: Xiang Gao, skillman, NJ (US); Visvanathan Ramesh, Plainsboro, NJ (US); Imad Zoghlami, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NJ (US)

(21) Appl. No.: 11/876,975

(22) Filed: Oct. 23, 2007

Related U.S. Application Data
(60) Provisional application No. 60/854,186, filed on Oct. 25, 2006.
(60) Provisional application No. 60/941,959, filed on Jun. 5, 2007.

(51) Int. Cl. G08G 1/017

(52) U.S. Cl. 340/937

(57) ABSTRACT

A method and system for background maintenance of a vision system by fusing a plurality of detection methods and applying a 1D analysis to verify an absence of a static vehicle is provided. Methods for analyzing spatial temporal images in vehicle detection systems are provided. A method for processing a 1-dimensional profile is provided to detect a static vehicle in a traffic lane. When no vehicles are detected, a background image may be updated. A method for processing a 1-dimensional profile is also provided to detect occlusions of a traffic lane by a vehicle in a neighboring traffic lane. A method to reduce false alarm in wrong way driver detection applies the method for occlusion detection. A method to detect a slow moving vehicle in a traffic lane from a spatial-temporal image is also disclosed. A system applying the methods for processing 1-dimensional profiles is also provided.

### CROSS-REFERENCE TO RELATED APPLICATIONS

This application claims the benefit of U.S. Provisional Application No. 60/854,186, filed Oct. 25, 2006 and U.S. Provisional Application No. 60/941,959, filed Jun. 5, 2007, which are both incorporated herein by reference in their entirety.

### BACKGROUND OF THE INVENTION

The present invention relates to the systematic evolution of the design of a traffic surveillance system to achieve significant gain in performance. More specifically, it relates to detecting anomalous traffic situations such as static vehicles, and slow vehicles.

The invention combines past patents on vehicle detection and tracking, systems engineering methodology for video surveillance, rank-order based change detection, along with novel innovations on global traffic scene analysis through the application of spatial temporal projections and classification and fusion. Concrete application of the system is for detecting anomalous traffic situations such as static vehicle detection, and slow vehicle detection, etc.

Different vehicle detection methods by image processing in traffic systems are known. These methods usually apply analysis of 2-dimensional (2D) images provided by one or more cameras. These methods can be very effective and reliable as was described in U.S. Pat. No. 6,999,004, filed Jun. 17, 2003, for a system for vehicle detection and tracking and which is incorporated herein by reference. That system uses a combination of cues such as illumination invariants, motion information, and object symmetry property to perform vehicle detection. The tracking algorithm uses application specific constraints (i.e. geometry priors). A background modeling technique along with change detection was used for detecting static vehicles. In order to enhance the performance of the system, as an aspect of the present invention, it is provided how to redesign the system described in the cited U.S. Pat. No. 6,999,004 using principles described in U.S. Pat. No. 7,079,992, filed on Jun. 5, 2002, which is incorporated herein by reference in its entirety.

Systematic fusion of the change detection measure in traffic situations from background update module, event state information after trajectory verification and 2D vehicle detection and tracking module states is desirable but currently not available.

Accordingly, novel and improved methods and systems for systematic fusion of a change detection measure in traffic situations from a background update module, event state information after trajectory verification and 2D vehicle detection and tracking module states are required.

### SUMMARY OF THE INVENTION

As an aspect of the present invention, it is provided how analysis of space-time projections (motivated by regularity in traffic flow) is utilized as a key cue to perform traffic flow analysis, truck vs. car classification, and serve as input to a more effective background update mechanism. Features in the space-time projection capture various effects including global/sudden illumination changes, local illumination changes due to neighboring lane traffic, and special signatures due to ongoing or outgoing traffic (cars, trucks).

In a further aspect of the present invention, it is provided how illumination invariant change detection that uses rank-order consistency can be utilized to verify that the background structure has not changed. Novel background representation using rank ordering of pixel values in a given block are used as the basis that is invariant to monotone changes in camera response function and illumination effects.

In another aspect of the present invention, it is also provided how to perform systematic fusion of the change detection measure from background update module, event state information after trajectory verification and 2D vehicle detection and tracking module states. This fusion module provides the decision logic that verifies consistencies between the 2D tracker and the space-time projection and static/slow vehicle detection modules in order to make a final decision.

In accordance with one aspect of the present invention, a method for delayed background maintenance of a scene from video data is provided, comprising fusing of a plurality of detection methods for determining a region for background update and verifying a presence of a static vehicle in the region by trajectory analysis from a one dimensional (1D) profile.

In accordance with another aspect of the present invention, the plurality of detection methods includes using a space-time representation that reduces traffic flow information into a single image, using of a two-dimensional (2D) vehicle detection and tracking module, and using an order consistency measure to detect a static vehicle region in the scene.

In accordance with a further aspect of the present invention, the method provides determining of the region using a space-time projection of the video data.

In accordance with another aspect of the present invention, the method comprises detecting occlusion of a traffic lane by a vehicle in a neighboring traffic lane.

In accordance with a further aspect of the present invention, the method further comprises using spatial temporal detection on the 1D profile to detect a region with no traffic in a traffic lane, and applying an order consistency block detector to a block of the region to identify a static vehicle region.

In accordance with another aspect of the present invention, the method comprises rejecting a static vehicle hypothesis by applying the 1D profile, and adapting a background block.

In accordance with a further aspect of the present invention, the method applies a 2D Detection and Tracking module to reject a presence of a static vehicle.

In accordance with another aspect of the present invention, the method comprises calculating a temporal gradient in the 1D profile of the traffic lane and determining a presence of a vehicle in the traffic lane using the temporal gradient.

In accordance with a further aspect of the present invention, the method comprises finding a strong change position from a spatial gradient in the profile and locating a non-vehicle region for background update.

In accordance with another aspect of the present invention, a vehicle is a static vehicle.

In accordance with a further aspect of the present invention, the method comprises updating a background image when it was determined that no vehicle was present.

In accordance with another aspect of the present invention, a segment of a neighboring traffic lane with a traffic direction opposite to the traffic lane is analyzed.

In accordance with a further aspect of the present invention, the method comprises calculating an absolute temporal gradient of a traffic lane profile, calculating a mean detection response from profiles of a plurality of segments, calculating an occlusion response, and determining that an occlusion occurred.

In accordance with another aspect of the present invention, the occlusion response is greater than a threshold value.

In accordance with a further aspect of the present invention, a vision system for processing image data from a scene is provided which can perform all the steps of the method provided above.

### DESCRIPTION OF THE DRAWINGS

FIG. 1 provides an illustrative example of spatial temporal images;

FIG. 2 is a spatial temporal image of a static vehicle;

FIG. 3 is a block diagram illustrating steps of a method in accordance with an aspect of the present invention;

FIG. 4 is a diagram illustrating segments of two neighboring traffic lanes;

FIG. 5 is a graphical presentation of probability distributions in accordance with an aspect of the present invention;

FIG. 6 is a space-time image illustrating vehicle detection in accordance with an aspect of the present invention;

FIG. 7 is a diagram of ideal orientation diagrams in accordance with an aspect of the present invention;

FIG. 8 is a diagram illustrating hypothesis testing in accordance with an aspect of the present invention;

FIG. 9 shows space-time images illustrating far distance, slow moving, vehicle detection in accordance with an aspect of the present invention; and

FIG. 10 illustrates a computer system that is used to perform the steps of methods described herein in accordance with another aspect of the present invention.

### DESCRIPTION OF A PREFERRED EMBODIMENT

A Spatial Temporal Image, or STI(t,s), is a way to efficiently store and use information of, for instance, a 2-dimensional video images. The vertical direction in a spatial temporal image is the spatial direction, s in STI(t,s). The horizontal direction in a spatial temporal image is the temporal direction, t. For instance STI(t,s) may be a spatial temporal image of a traffic lane in a tunnel. For a fixed value of t, STI(t,s) is the ID profile of the lane image.

Let (x, y) be the coordinate of a pixel. Assume MLᵢ(x, y) to be the mask function of the i-th lane:

$${ML}_{i} ( x , y ) = \{ \begin{matrix}1 & ( x , y ) ∈ lane i \\ 0 & otherwise\end{matrix}$$

The ID profile of the lane image at time t is:

$${STI}_{i}^{( t )} ( y ) = \frac{{\sum }_{x} {I}^{( t )} ( x , y ) \cdot {ML}_{i} ( x , y )}{{\sum }_{x} {ML}_{i} ( x , y )}$$

wherein I^{(t)} (x, y) is the image at time t.

FIG. 1 shows examples of spatial temporal images. The two images 101 and 102 show the traffic information of two different lanes in a tunnel in the same time period. In image 101, the default lane direction is from top to bottom, while the default direction of the lane in the image 102 of FIG. 1 is from bottom to the top. The horizontal axis provides the time and the vertical axis provides the position of a vehicle.

For a 2D system for detection of vehicles in a tunnel it is required to update the system regularly for changed illumination conditions as to have a background image of the tunnel with no vehicles present. It is particularly of importance to make sure that no non-moving or static vehicle is present in the tunnel before updating a background image.

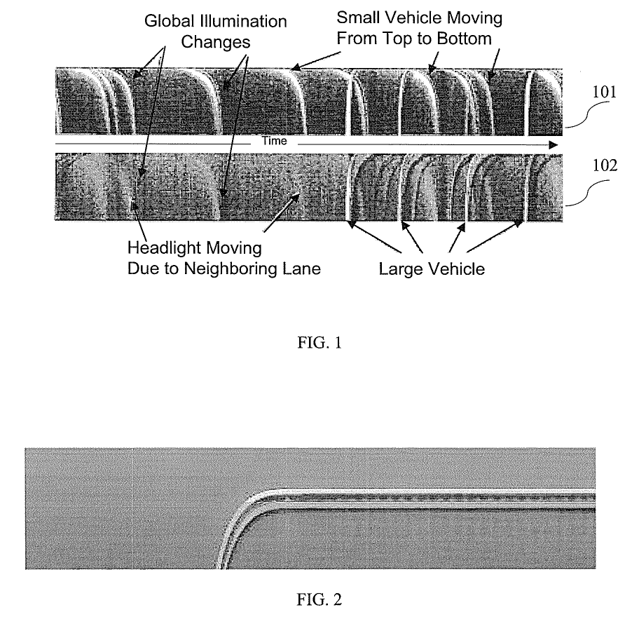

FIG. 2 shows a spatial temporal image of a vehicle which has come to a stop.

Static Vehicle Detection

Part of the static vehicle detection is based on the Dr. Anurag Mittal's order consistency block detection algorithm, which is for instance, disclosed in U.S. patent application Ser. No. 11/245,391, filed on Oct. 6, 2005, by Mittal et al., and which is incorporated herein by reference in its entirety. Based on this algorithm, a more than 100% speedup by modifying the processing pipeline was achieved.

As an aspect of the present invention, static vehicles in a tunnel will be detected by analyzing spatial temporal images rather than using 2D detectors. The main reasons not to use a 2D detection and tracking module for detecting the static vehicle are:

for the oncoming vehicle, it is possible that the vehicle stops before it reaches the detection zone. When this happens, a 2D detector will never detect the vehicle.

the system is required to detect any vehicle which could be 75 meters away from the camera. It could be approximately 4 by 12 pixels in the video. For this kind of object size, the robustness of the “template match” algorithm used in the tracking algorithm is questionable

niche detection is required. Inside the niche lane, the motion might not happen at all.

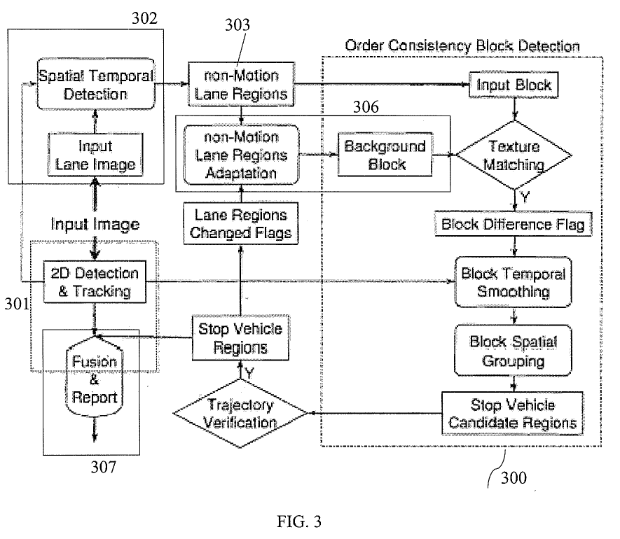

The manual version of the order consistency block detection algorithm needs the user to manually initialize the background image which should have no vehicle in the image. In order to handle the illumination variations in the tunnel, an automatic background maintenance method for the tunnel scenario is provided. A block diagram of the method for static vehicle detection is provided in FIG. 3.

The diagram of FIG. 3 includes the following functions:

1) Order Consistency Block Detection. By matching the texture of two blocks, the “order consistency block detection” determines whether there is a significant difference between the two blocks. This is a region based detector, not a pixel based detector. A valid candidate of the static vehicle should satisfy both of the following conditions:

the texture of the input block is different from the texture of the background block.

the texture of the input block is similar to the textures of input blocks in the past several frames. The aspects of Order Consistency Block Detection have been explained in the earlier cited U.S. patent application Ser. No. 11/245,391.

2) Spatial Temporal Detection (more detail will be provided in a later section). The spatial and temporal information of a spatial temporal image will be used to detect the possible place where no motion happens. These are the possible places where the static vehicle event could happen. Since there is no more than 1 vehicle moving at the same location of the same lane at the same time, one can simplify the algorithm complexity and the running cost. The 1D profile will be used instead of the real 2D image to present the lane information at a particular time. The detection is based on the temporal difference between the 1D profiles at 2 consecutive times. For any position in the 1D profile, if the temporal difference is larger than a threshold, it is assumed there is a motion or change at that place.

3) non-Motion Lane Regions. The “order consistency block detector” will run at a block when there is at least one position in the corresponding 1D profile that does not have significant motion. The motion is checked using the spatial temporal detection.

4) non-Motion Lane Region Adaptation. Instead of doing a region level adaptation directly, what will be used is adapting each pixel in the block separately. Then next, the texture of the background block is recalculated for the “order consistency block detection”. In order to handle the variations caused by the illumination change and the dynamic camera gain, each pixel in the block is only adapted when, for the whole block, there is no position that has motion in the corresponding 1D profile and there is no valid static vehicle detection in the block.

5) Trajectory Verification (more detail is provided in a later section). This is the procedure to distinguish the alarm caused by the sudden local lighting changes from the alarm caused by the real static vehicle.

Spatial Temporal Detection

Based on a real life scenario for traffic in a tunnel, the spatial temporal detection is applied to each lane in a tunnel separately.

Accumulation. Define an accumulation function AF(y) as:

$${AF}^{( t )} ( y ) = \frac{{\sum }_{x} {I}^{( t )} ( x , y ) \cdot ML ( x , y )}{{\sum }_{x} ML ( x , y )}$$

wherein I^{(t)} (x, y) is the t-th frame image and ML(x,y) is the mask for the lane.

Calculate Temporal Gradient. The absolute value of the temporal gradient of the accumulation function at time t, ATG^{(t)}(y), is
ATG^{(t)}(y)=|SSAF^{(t+1)}(y)−SSAF^{(t-1)}(y)|.
SSAF^{(t)}(y), the spatial smoothed accumulation function, can be calculated as

$${SSAF}^{( t )} ( y ) = \frac{{\sum }_{j = - J}^{J} {AF}^{( t )} ( y + j ) \cdot {f}_{s} ( j )}{{\sum }_{j = - J}^{J} {f}_{S} ( j )}$$

wherein f_{S}(j), j=−J . . . , J is a predefined spatial smoothing function.

Calculate Spatial Gradient. The absolute value of the spatial gradient of the accumulation function at time t, ASG^{(t)}(y), is
ASG^{(t)}(y)=|TSAF^{(t)}(y+1)−TSAF^{(t)}(y−1)|.
TSAF^{(t)}(y), the temporal smoothed accumulation function can be calculated as

$${TSAF}^{( t )} ( y ) = \frac{{\sum }_{j = - J}^{J} {AF}^{( t + j )} ( y ) \cdot {f}_{t} ( j )}{{\sum }_{j = - J}^{J} {f}_{t} ( j )}$$

wherein fₜ(j), j=−J, . . . , J is a predefined temporal smoothing function.

Find Strong Change Position. The strong change position, SCP^{(t)}(y), is where the spatial gradient and the temporal gradient are reasonably large. It is the evidence that, at a particular time, either a strong lighting change or a vehicle appears at that position. Moreover, it has a very high probability to be part of the boundaries of the strong lighting change area or the vehicle.

$${SCP}^{( t )} ( y ) = \{ \begin{matrix}1 & {ATG}^{( t )} ( y ) \cdot {ASG}^{( t )} ( y ) > {T}_{p} \\ 0 & otherwise\end{matrix}$$

wherein Tₚ is a predefined threshold.

Locate Possible non-Motion Region. The strong lighting change area or the vehicle is a physical continuous object and has a reasonably large size. When the strong change position is located, the morphological closing operation is applied to grouping the strong change positions into blocks. The remaining places are the possible non-Motion regions. The parameters of the morphological closing operator are determined by:

typical size of a vehicle at a location.

the estimated velocity of the vehicle in the lane.

Non-Motion Lane Regions Adaptation

A pixel level background image will be maintained in the system. For each block which does not have significant motion, the adaptation will be applied to each pixel in the block using an exponential forgetting method described by:
B^{(t+1})(x,y)=(1−α)B^{(t)}(x,y)+αI^{(t)}(x,y)
The Role of 2D Detection and Tracking

The performance of the 2D detection and tracking module is very good. It can reliably detect and track more than 98% of moving vehicles in the traffic lanes. The 2D detection and tracking algorithm is providing the following information to the static vehicle detection module:

The “vehicle moving in the lane” event and the “static vehicle in the lane” event are mutually exclusive occurrences. The static vehicle alarm in the traffic lane will be cancelled if, at the same time, a vehicle is detected and tracked successfully in the same lane.
Whenever the 2D detection and tracking module detects a moving vehicle, the system will reset the “block temporal smoothing” function in the “order consistency block detection” segment, as shown in FIG. 3.
Whenever the 2D detection and tracking module detects a moving vehicle, the velocity of the vehicle can be estimated. The estimated velocity is used in the “spatial temporal detection” function of the method of which a diagram is shown in FIG. 3, to minimize the chance that the background adaptation blends part of the moving vehicle into the background.
Whenever there is a “slow vehicle” alarm or a “congestion” alarm, the background adaptation procedure will be paused. And if, at that time, the static vehicle alarm is triggered, the alarm will be cancelled.

Accordingly, a system is provided that, as shown in FIG. 3, allows for delayed background maintenance of a vision system by fusion of several detection methods. Aspects of the present invention systematically evolve methods on vehicle detection and tracking (301) as disclosed in U.S. Pat. No. 6,999,004, issued on Feb. 14, 2006, which is incorporated herein by reference in its entirety. Accordingly, aspects of the present invention enhance the overall performance of a tunnel monitoring solution.

The module output for 2D detection and tracking from cited U.S. Pat. No. 6,999,004 is augmented by the use of a combination of:

a) a space-time representation that summarizes traffic flow information into a single image (302).

b) a novel classifier and fusion scheme for identifying specific regions in the image wherein the background model can be updated—the feature space used is the space-time projection of the video data that allows for quick classification (303).

c) the use of order consistency based change detection as further disclosed in U.S. Pat. No. 7,006,128, issued Feb. 28, 2006, which is incorporated herein by reference in its entirety and in earlier cited patent application Ser. No. 11/245,391, as an illumination invariant change detection measure to detect potential static or static vehicle regions in the scene, (300).

c) the verification of static vehicle region hypotheses via trajectory analysis from the 1D profile, and

d) the feedback of the static vehicle region hypotheses in the background update process.

To fuse these multiple cues together, a systematic approach is followed by first characterizing properly the event to be detected. For instance, a static vehicle can be characterized by a change from the currently maintained background and the detected change must be static. The second step is to identify which cues are relevant for the event to be detected. For instance, for the static vehicle an order consistency change will support the hypothesis of a presence of a vehicle while the presence of a moving vehicle detected by the 2D detection and tracking module will reject this hypothesis. Finally, these cues are combined to make a final decision. This combination uses the product of likelihoods. To estimate the likelihood of each cue, the distribution of the cue feature observed using real data as well as simulation are used. A fusion and reporting step is provided in 307 of FIG. 3

Wrong Way Driver False Alarm Reduction

The method of 1D or spatial temporal image analysis can also be applied in other aspects of traffic monitoring. For instance, it can also be applied in the reduction of false alarms for “wrong way driver” detection.

There is some strong prior knowledge that can be applied in multi-lane traffic monitoring:

for most of the time a vehicle moves in a fixed direction within a lane, though a vehicle does change lanes sometimes.

there cannot be multiple vehicles moving in the same lane at the same location at the same time.

The same mask function MLᵢ(x,y) and the ID profile STIᵢ^{(t)}(y) of a lane image at time t as defined before will be applied. One is again referred to FIG. 2 for an example of spatial temporal images.

The Siemens Advanced Detection Solution (SiADS) has a wrong way driver detection algorithm. It comprises the steps:

1. vehicle candidates in each lane are detected at the vehicle detection zone.

2. vehicle candidates are verified by tracking the candidates over time. The invalid candidates are unlikely to satisfy the tracking criterion.

3. the moving direction of a vehicle is identified during the tracking procedure.

4. if the moving direction of a vehicle is not the same as the lane's default direction, a wrong way driver alarm will be generated.

This algorithm works well when the default directions of all of the lanes are the same. The direction can either be the coming direction or the leaving direction from the camera. When both the lane with the leaving direction and the coming direction exist in a scene, the algorithm sometimes may generate a false alarm. The typical false alarm scenario is the following:

1. When a big vehicle enters the scene, due to the geometry constraints, an occlusion happens, as in the video part of the big vehicle appears in the region inside a neighboring zone.

2. The occlusion triggers a vehicle candidate detection in the vehicle detection zone of neighboring lanes.

3. When the vehicle moves, in the video the occlusion keeps appearing and moving on neighboring lanes. Under certain circumstances, the occlusion can pass the tracking verification. The system then treats the occlusion as a valid vehicle moving in a neighboring lane.

4. When the default directions of neighboring lanes are the same as the lane with the vehicle, only a counting error of the neighboring lanes will be generated. However, when the default directions of vehicle lane and a neighboring lane are different, a wrong way driver will be triggered.

One can derive from the above description that the false alarm of the wrong way driver is mainly caused by occlusion. The false alarm reduction for the wrong way driver detection in accordance with an aspect of the present invention is based on the logic that the system can not really tell what is happening when a lane is occluded. Accordingly, the system should not fire the wrong way driver alarm for that lane at that time. If the system can detect when the occlusion happens, then the system can cancel the wrong way driver alarm if the occlusion happened at the same time as the wrong way driver detection.

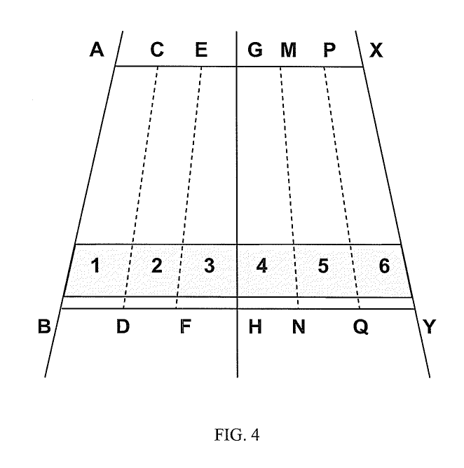

A 2-lane setting as shown in FIG. 4 will be used as an illustrative example to describe the false alarm reduction algorithm in accordance with an aspect of the present invention.

FIG. 4 shows in diagram 2 lanes: left lane 0 between the lines AB and GH, and right lane 1 between the lines GH and XY. Each line is equally partitioned into S(=3) segments. Each segment has a segment index (1, 2, 3, 4, 5, 6) as shown in FIG. 4. The shaded region of the lanes is the region where occlusion detection will be applied, using spatial temporal images.

The mask function as previously defined will be used, however a mask function will now be defined for the s-th segment of the i-th lane:

$${M}_{i , x} ( x , y ) = \{ \begin{matrix}1 & ( x , y ) ∈ shaded region of lane i , segment s \\ 0 & otherwise\end{matrix}$$

In each segment s one should apply:

Accumulation. The accumulation function AF_{i,s}(y) was defined earlier and is written for segment s in lane i as:

$${AF}_{i , s}^{( t )} ( y ) = \frac{{\sum }_{x} {I}^{( t )} ( x , y ) \cdot {ML}_{t , s} ( x , y )}{{\sum }_{x} {ML}_{i , s} ( x , y )}$$

where I^{(t)}(x,y) is the image at time t.

Calculate Gradient in Time. This is again similar as the temporal gradient as used in determining the static vehicle, but now defined for a segment s in a lane i. The absolute value of the temporal gradient of the accumulation function is evaluated for each of the segments. The spatial smoothed accumulation function SAF_{i,s}^{(t)}(y) can be calculated as:

$${SAF}_{i , s}^{( t )} = \frac{{\sum }_{j = - J}^{J} {A}_{i , s}^{( t )} ( y + j ) \cdot f ( j )}{{\sum }_{j = - J}^{J} f ( j )}$$

where f(j), j=−J, . . . , J is a predefined smoothing function. The absolute gradient at time t, AG_{i,s}^{(t)}(y), is
AGᵢ^{(t)}(y)=|log SAF_{i,s}^{(t)}(y)−log SAF_{i,s}^{(t-1)}(y)|.

The Mean Detection Response of each segment is

$${MAG}_{i , s}^{( t )} = \frac{1}{H} {\sum }_{y} {AG}_{i , s}^{( t )} ( y ) ,$$

where H is the number of y in each segment.

Occlusion Response. The occlusion response can be calculated based on the location of the camera. Suppose the camera is located at the right side of the road. A vehicle on lane 1 may generate an occlusion on lane 0. The occlusion response OR^{(t)} can be calculated as

$${OR}^{( t )} = {min}_{ s = 3 , … , 6} {MAG}_{ i , s}^{( t )} .$$

When the response is greater than a threshold the system will assume that there is an occlusion on lane 0 which is triggered by a vehicle on lane 1.

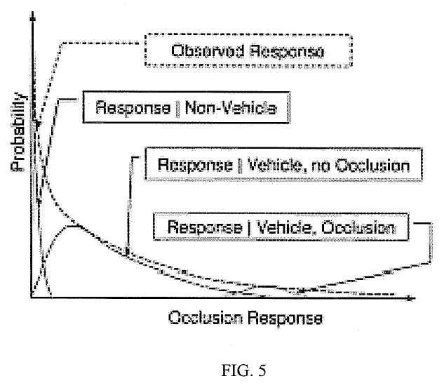

The threshold can be learned online. FIG. 5 shows different curves of the probability distribution for different occurrences. From FIG. 5 it is easy to notice that the distribution of the observed occlusion response is a mixture of three different components. These are:

1. response when no vehicle is in a scene.

2. response when there is a vehicle in a scene, but the vehicle does not generate an occlusion.

3. response when there is a vehicle in a scene and the vehicle generates an occlusion.

The observed response can be derived from the component distributions by using weight factors. The weight parameters are time varying variables. They depend on the traffic flow that happens in the region in a particular time window. In accordance with an aspect of the present invention, the distribution of the OR^{(t)} is approximated as an exponential distribution where the parameter X can be estimated from the median value of OR^{(t)} in a time window. Herein the distribution function is provided by

$$f ( x \vert λ ) = \frac{1}{λ} {ⅇ}^{- \frac{x}{λ}} and λ = {median}_{t ∈ Time Window} \{ {OR}^{( t )} \}$$

A parameter T needs to satisfy

$${\int }_{0}^{T} f ( x \vert λ ) ⅆ x = 1 - {ⅇ}^{- \frac{T}{x}} = P where$$

P is a predefined miss detection probability.

The estimated distribution is a function of the traffic status in the time window. When there are few vehicles passing in the time window, the estimated \hat{T} will be close to 0 while it could be very large when there are many big trucks passing in the time window. In one example, the time window is set to be 10 minutes. In order to handle different traffic conditions, the system may be restricted to allow the threshold to be varied in a predefined range.

As an aspect of the present invention, a method has been provided to create a 1D profile of a traffic lane, which can also be a segment of a traffic lane. A 1D profile can be processed to locate a possible non-Motion region having a static vehicle in a traffic lane. The absence of detection of a non-Motion region can be used to determine the right moment for background maintenance of a vehicle detection system. A 1D profile of a segment of a traffic lane can be processed to detect occlusion of a segment of a traffic lane by a large vehicle in a neighboring lane. Detection of occlusion can be used to reduce false alarms of wrong way driver detection.

Slow Moving Vehicles

As a further aspect of the present invention, one can also apply spatial temporal images for detecting slow moving vehicles.

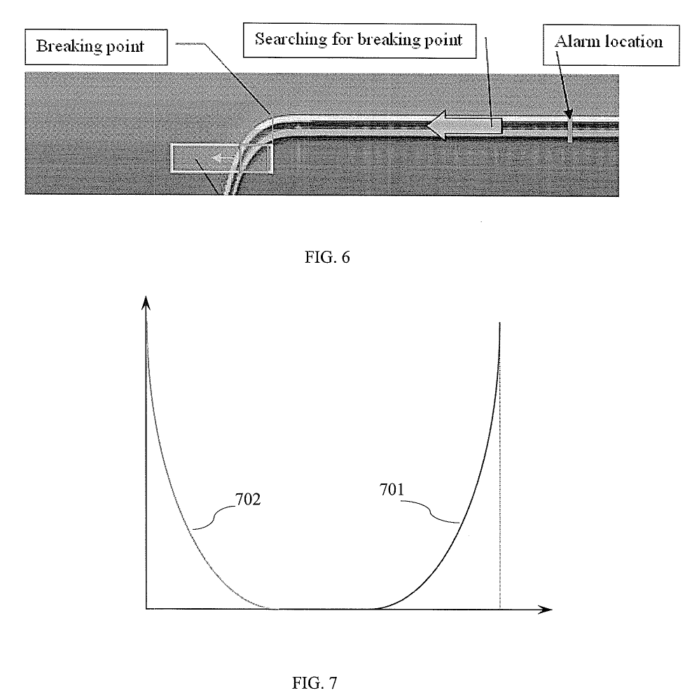

At a given location, a given velocity of a vehicle, the curvature of the trajectory in the space-time image is different as can be seen in FIG. 6. This can be used as a measurement of the velocity of the vehicle. If the detection candidate is a static vehicle, when one traces the trajectory back, it is possible to detect the slowing down process. The size of the rectangle in FIG. 6 is determined by the geometry of the scene. It corresponds to a normal size of a vehicle at the hypothesis location.

Assume θᵢ is the observation at the position i, ∥gᵢ∥ is the magnitude of the gradient, σᵢ² is the uncertainty of the grayscale value. Normally, it is small when the value [5,235] it is huge otherwise.

The gradient orientation of each location in the space-time image is calculated and the orientation histogram is used as a feature and is provided in the following expression.

$$h ( θ ) = \frac{1}{n} {\sum }_{i} N ( {θ}_{i} , \frac{{σ}_{i}^{2}}{{‖ {g}_{i} ‖}^{2}} ) .$$

The matching measurement is the Bhattacharyya distance between 2 orientation histograms. To classify the state the observed histogram will be compared with two ideal distributions. In FIG. 7, the curve 701 represents the ideal orientation distribution of a static vehicle (there are no changes in time direction, horizontal direction; in space direction, the road texture is there). The curve 702 presents the ideal orientation distribution of sudden illumination changes or a vehicle moves in an extremely fast, strong motion, (the changes in time direction is much stronger than the changes in space). By comparing the observed orientation histogram with the 2 above ideal distributions, one can estimate the velocity of the moving vehicle.

The Slow Moving Vehicle Hypothesis Test includes 2 parts.

1. In a short time window right before the braking point, calculate the orientation histogram for each possible time. The best candidate is the location where the distance between the ideal static vehicle template and the orientation histogram at that location is maximized.

2. At the best candidate location, the distance between the strong motion template and the orientation histogram is calculated. The orientation histogram of a slow moving vehicle should be not only far from the strong motion template, but also far from the ideal static vehicle template.

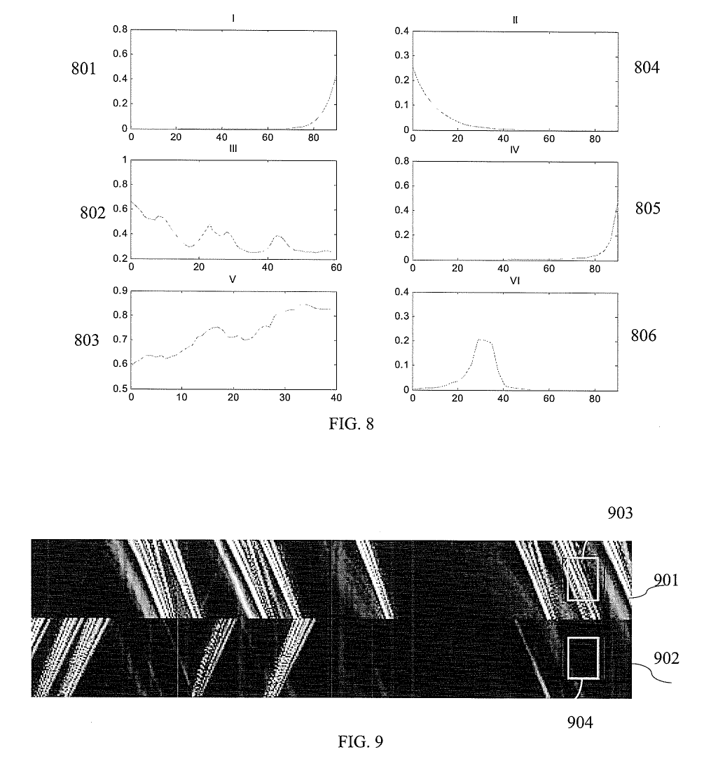

FIG. 8 shows the example of the slow moving vehicle hypothesis testing result. Graph I in 801 is the ideal angle distribution of the static vehicle. Graph II in 804 is the ideal angle distribution of the fast moving vehicle. Graph III in 802 shows the matching scores in finding the best candidate. Graph IV in 805 shows the angle distribution of the found candidate. Graph V in 803 shows the matching scores of the slow motion hypothesis. Graph VI in 806 is the angle distribution of the located slow motion candidate.

In the far distance, due to the geometry of the camera, the directions of the gradient under different velocities are similar. In order to distinguish the slow moving vehicle from others, autocorrelation method is applied.

FIG. 9 shows a Gradient Image of Unwarped Space-Time Image in Far Distance. Two directions of traffic are displayed. The top image 901 is the incoming direction, the bottom image 902 is the leaving direction.

In the far distance, the procedure for detection is:
1. Unwarp the far distance part of the spatial temporal image using homography information.
2. Calculate the magnitude of the gradient of the unwarped spatial temporal image. The white lines in FIG. 9 are the high gradient magnitude regions. Normally, they correspond to the trajectories of the moving vehicle. The slope of the lines indicates the velocity of the vehicles.
3. Use the patch inside the rectangle (903 and 904) as template to calculate the matching score for each possible direction (related to each possible vehicle velocity). The vehicle velocity estimation is based on the most significant direction of the correlation. This is the velocity information in a particular region at a certain time.

Accordingly one can detect near and far distance slow moving vehicles by analyzing spatial temporal images of a traffic lane.

System

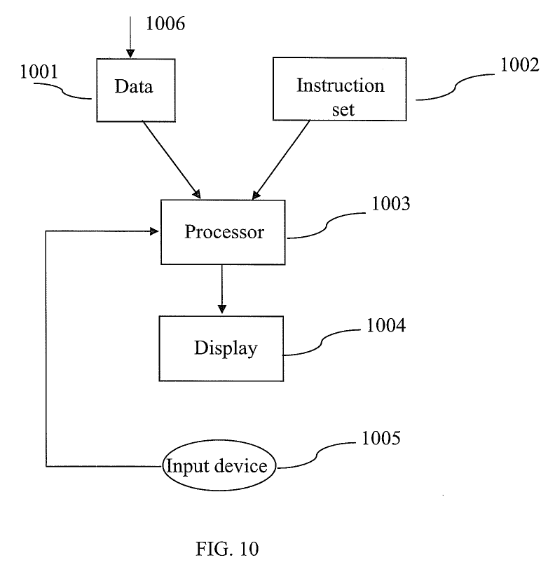

The static vehicle detection, the slow moving vehicle detection, the fusion, the delayed background maintenance, and the occlusion detection methods, and other methods that are aspects of the present invention, can be executed by a system as shown in FIG. 10. The system is provided with data 1001 representing image data. This image data may be provided, for instance, in real-time on an input 1006. An instruction set or program 1002 executing the methods of the present invention is provided and combined with the data in a processor 1003, which can process the instructions of 1002 applied to the data 1001. A result which may include an image or an alert can be outputted on an output device 1004. Such an output device may be a display or any other output device. The result may be used for further processing such as initiating background maintenance. The processor can be dedicated hardware. However, the processor can also be a CPU or any other computing device that can execute the instructions of 1002. An input device 1005 like a mouse, or track-ball or other input device may be present to allow a user to select an initial object or to start or stop an instruction. However, such an input device may also not be present. Accordingly, the system as shown in FIG. 10 provides a system for using methods disclosed herein.

The term ‘non-motion region’ is used herein. A ‘non-motion region’ can also be named a ‘static region’; the two terms ‘non-motion region’ and ‘static region’ are intended to mean the same herein. The same applies to the terms ‘static’ and ‘non-motion’, which are intended to mean the same and to ‘static’ and ‘non-moving’.

The following patent application and patents, including the specifications, claims and drawings, are hereby incorporated by reference herein, as if they were fully set forth herein: U.S. patent application Ser. No. 11/245,391, filed on Oct. 6, 2005 entitled Video-based Encroachment Detection; U.S. Pat. No. 6,999,004, issued on Feb. 14, 2006, entitled System and Method for Vehicle Detection and Tracking; U.S. Pat. No. 7,006,950, issued on Feb. 28, 2006, entitled Statistical Modeling and Performance Characterization of a Real-time Dual Camera Surveillance System; U.S. Pat. No. 7,079,992, issued on Jul. 18, 2006, entitled Systematic Design Analysis for a Vision System.

While there have been shown, described and pointed out, fundamental novel features of the invention as applied to preferred embodiments thereof, it will be understood that various omissions and substitutions and changes in the form and details of the methods and system illustrated and in its operation may be made by those skilled in the art without departing from the spirit of the invention. It is the intention, therefore, to be limited only as indicated by the scope of the claims appended hereto.

1. A method for delayed background maintenance of a scene from video data, comprising:
fusing of a plurality of detection methods for determining a region for background update; and
verifying a presence of a static vehicle in the region by trajectory analysis from a one dimensional (1D) profile.

2. The method as claimed in claim 1, wherein the plurality of detection methods includes
using a space-time representation that reduces traffic flow information into a single image;
using of a two-dimensional (2D) vehicle detection and tracking module; and
using an order consistency measure to detect a static vehicle region in the scene;

3. The method as claimed in claim 1, wherein determining of the region uses a space-time projection of the video data.

4. The method as claimed in claim 1, further comprising detecting occlusion of a traffic lane by a vehicle in a neighboring traffic lane.

5. The method as claimed in claim 1, further comprising:
using spatial temporal detection on the 1D profile to detect a region with no traffic in a traffic lane; and
applying an order consistency block detector to a block of the region to identify a static vehicle region.

6. The method as claimed in claim 1, further comprising:
rejecting a static vehicle hypothesis by applying the 1D profile; and
adapting a background block.

7. The method as claimed in claim 1, wherein a 2D Detection and Tracking module is applied to reject a presence of a static vehicle.

8. The method as claimed in claim 5, further comprising:
calculating a temporal gradient in the 1D profile of the traffic lane; and
determining a presence of a vehicle in the traffic lane using the temporal gradient.

9. The method as claimed in claim 8, further comprising:
finding a strong change position from a spatial gradient in the profile; and
locating a non-vehicle region for background update.

10. The method as claimed in claim 8, wherein the vehicle is a static vehicle.

11. The method as claimed in claim 1, further comprising updating a background image when it was determined that no vehicle was present.

12. The method as claimed in claim 1, wherein a segment of a neighboring traffic lane with a traffic direction opposite to the traffic lane is analyzed.

13. The method as claimed in claim 12, further comprising:
calculating an absolute temporal gradient of a traffic lane profile;
calculating a mean detection response from profiles of a plurality of segments;
calculating an occlusion response; and
determining that an occlusion occurred.

14. The method as claimed in claim 13, wherein the occlusion response is greater than a threshold value.

15. The method as claimed in claim 1, further comprising detecting a slow moving vehicle.

16. A vision system for processing image data from a scene, comprising:
a processor;
software operable on the processor to:
fusing of a plurality of detection methods for determining a region for background update; and
verifying a presence of a static vehicle in the region by trajectory analysis from a one dimensional (1D) profile.

17. The system as claimed in claim 16, wherein the plurality of detection methods includes:
using a space-time representation that reduces traffic flow information into a single image;
using of a two-dimensional (2D) vehicle detection and tracking module; and
using an order consistency measure to detect a static vehicle region in the scene.

18. The system as claimed in claim 16, wherein determining of the region uses a space-time projection of the video data.

19. The system as claimed in claim 16, further comprising detecting occlusion of a traffic lane by a vehicle in a neighboring traffic lane.

20. The system as claimed in claim 16, further comprising:
using spatial temporal detection on the 1D profile to detect a region with no traffic in a traffic lane; and
applying an order consistency block detector to a block of the region to identify a static vehicle region.

21. The system as claimed in claim 16, further comprising:
rejecting a static vehicle hypothesis by applying the 1D profile; and
adapting a background block.
